(19) United States
(12) Patent Application Publication
(10) Pub. No.: US 2025/0040706 A1
(43) Pub. Date: Feb. 6, 2025

(54) SOLAR-POWERED LOUNGE CHAIR

(71) Applicant: Kimberly Fee, Surprise, AZ (US)

(72) Inventor: Kimberly Fee, Surprise, AZ (US)

(21) Appl. No.: 18/229,150

(22) Filed: Aug. 1, 2023

(51) Int. Cl. A47C 1/032; A47C 1/14; A47C 7/54; A47C 7/72; H02S 20/30; H02S 40/38

(52) U.S. Cl. CPC A47C 1/03211; A47C 1/143; A47C 7/54; A47C 7/72; H02S 20/30; H02S 40/38

(57) ABSTRACT

A chair apparatus for adjusting a backrest with solar power to support a user in multiple positions includes a support frame and a seat coupled to the support frame. The seat has an upper surface configured for supporting a user. The backrest is pivotally coupled to the seat and is movable between a lowered position and a raised position. A lift mechanism is operably coupled to the backrest wherein the lift mechanism is operable to move the backrest between the lowered position and the raised position. A solar panel is electrically coupled to a battery which supplies electricity to the lift mechanism.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to lounge chairs and more particularly pertains to a new lounge chair for adjusting a backrest with solar power to support a user in multiple positions.

### (2) Description of Related Art Including Information Disclosed Under 37 CFR 1.97 and 1.98

The prior art describes myriad lounge chairs, including lounge chairs which use solar power to charge electronics and alternately raise and lower a backrest of the lounge chair. However, the prior art does not disclose such a lounge chair which uses a solar panel mounted rearwardly of the backrest to power a lift mechanism for the backrest and which is controllable via an armrest-mounted input. Such an apparatus would provide an alternative to the lounge chairs of the prior art by mounting the solar panel away from a user lying on the lounge chair and mounting the input in an area reachable by the user when using the lounge chair.

### BRIEF SUMMARY OF THE INVENTION

An embodiment of the disclosure meets the needs presented above by generally comprising a support frame and a seat coupled to the support frame. The seat has an upper surface configured for supporting a user. A backrest is pivotally coupled to the seat and is movable between a lowered position and a raised position. A body support surface of the backrest facing upwardly and lying coplanar to the upper surface of the seat when the backrest is positioned in the lowered position and forms an obtuse angle with the upper surface of the seat when the backrest is positioned in the raised position. A lift mechanism is operably coupled to the backrest wherein the lift mechanism is operable to move the backrest between the lowered position and the raised position. A power supply is electrically coupled to the lift mechanism and comprises a battery. A solar panel is electrically coupled to the battery.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front first side perspective view of a chair apparatus according to an embodiment of the disclosure.

FIG. 2 is a top front second side perspective view of an embodiment of the disclosure.

FIG. 3 is a side view of an embodiment of the disclosure.

FIG. 4 is a bottom view of an embodiment of the disclosure.

FIG. 5 is a rear second side view of an embodiment of the disclosure.

FIG. 6 is a detail view of an embodiment of the disclosure taken from FIG. 1.

### DETAILED DESCRIPTION OF THE INVENTION

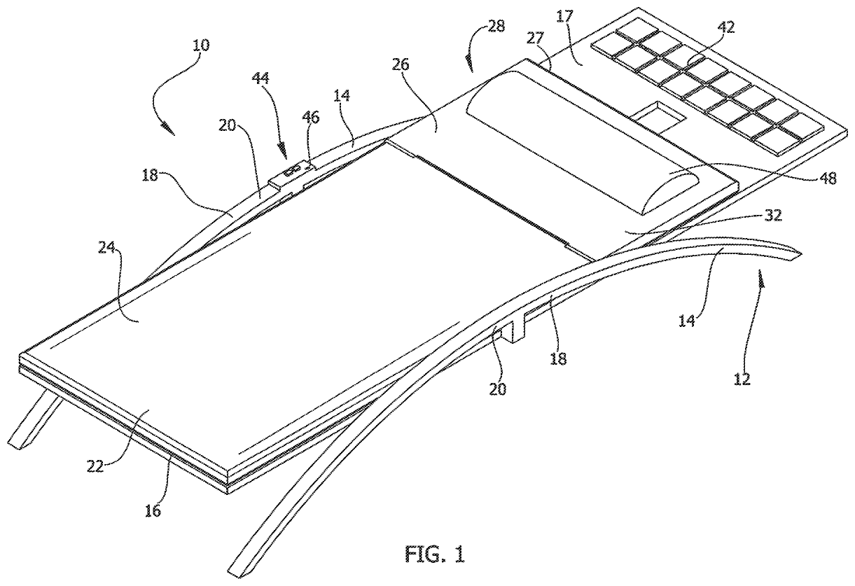

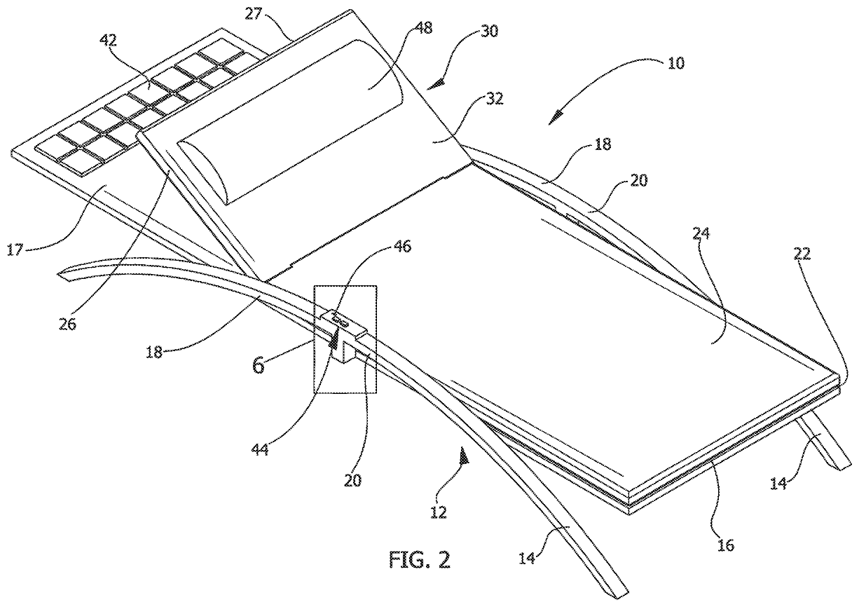

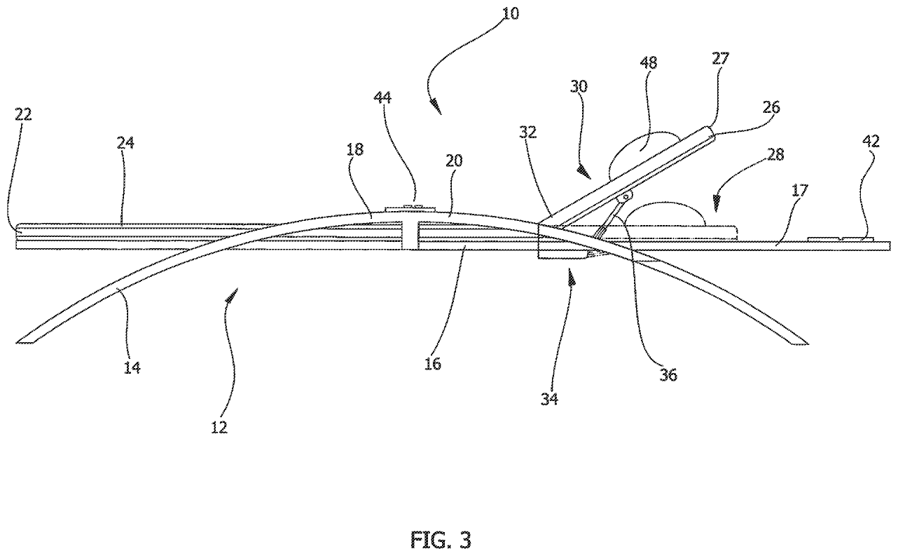

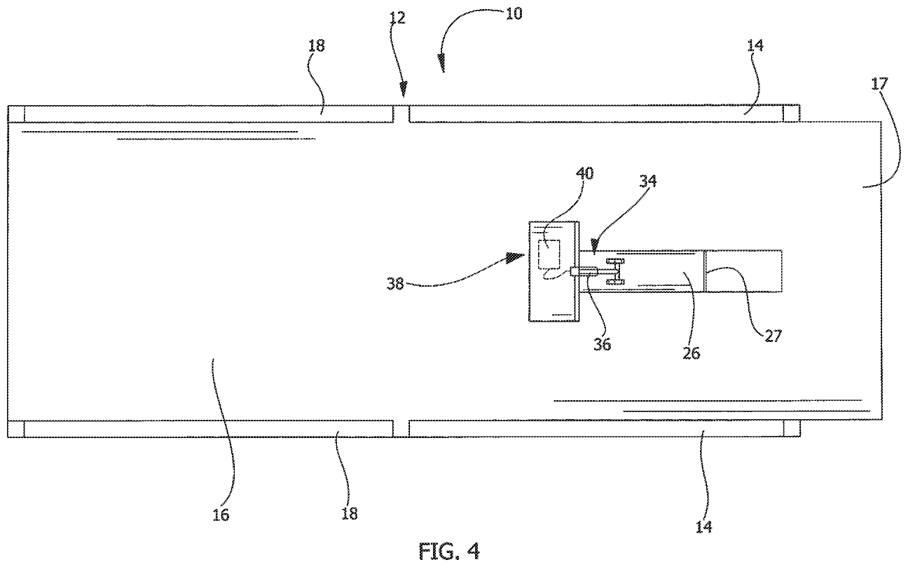

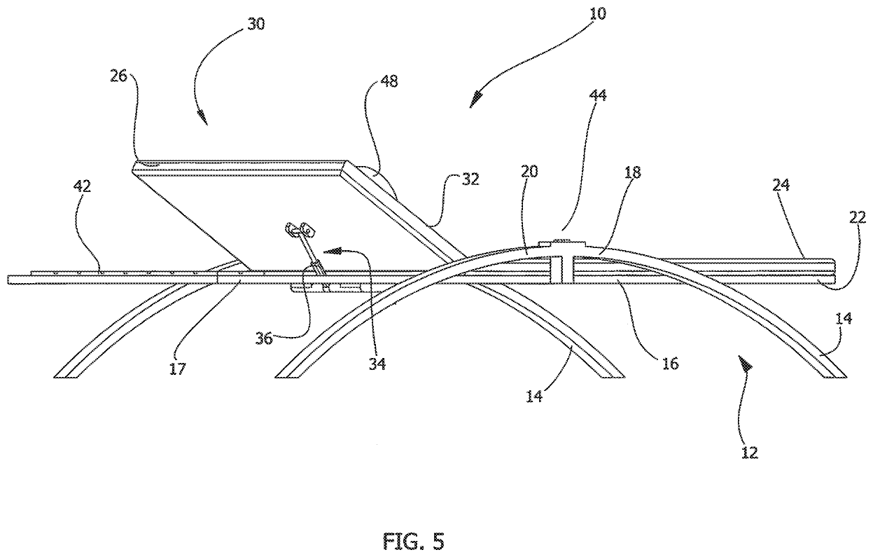

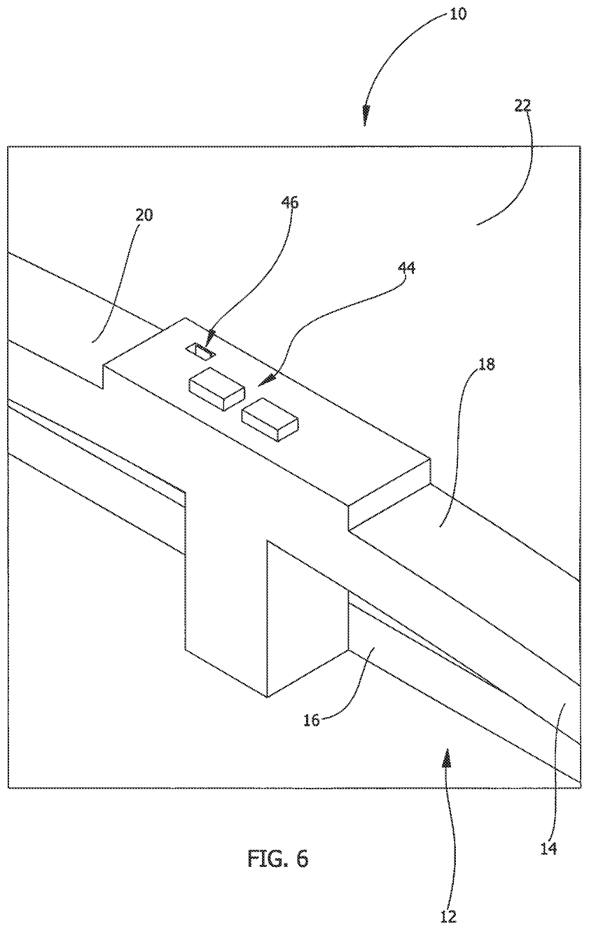

With reference now to the drawings, and in particular to FIGS. 1 through 6 thereof, a new lounge chair embodying the principles and concepts of an embodiment of the disclosure and generally designated by the reference numeral 10 will be described.

As best illustrated in FIGS. 1 through 6, the chair apparatus 10 generally comprises a support frame 12 comprising a pair of legs 14 and a main body 16. The main body 16 is coupled to and extends between the pair of legs 14. Each leg 14 of the pair of legs 14 is elongated and has an arch shape. A central portion 17 18 of each leg 14 of the pair of legs 14 is spaced upwardly from the main body 16 and defines one of a pair of armrests 20. A seat 22 is coupled to the support frame 12 and has an upper surface 24 configured for supporting a user. The seat 22 is positioned on the main body 16. A backrest 26 is pivotally coupled to the seat 22 and is movable between a lowered position 28 and a raised position 30. A body support surface 32 of the backrest 26 faces upwardly and lies coplanar to the upper surface 24 of the seat 22 when the backrest 26 is positioned in the lowered position 28. The body support surface 32 forms an obtuse angle with the upper surface 24 of the seat 22 when the backrest 26 is positioned in the raised position 30.

A lift mechanism 34 is operably coupled to the backrest 26 wherein the lift mechanism 34 is operable to move the backrest 26 between the lowered position 28 and the raised position 30. The lift mechanism 34 comprises a linear actuator 36, which may comprise a leadscrew, a hydraulic cylinder, a pneumatic cylinder, or the like. A power supply 38 is electrically coupled to the lift mechanism 34 and comprises a battery 40. The power supply 38 is mounted to the support frame 12. A solar panel 42 is electrically coupled to the battery 40 and is mounted to the support frame 12. The solar panel 42 is positioned on a portion 17 of the main body 16 which extends outwardly from a distal edge 27 of the backrest 26 relative to the seat 22 when the backrest 26 is positioned in the lowered position 28. An input 44 is operatively coupled to the lift mechanism 34 and is mounted to the support frame 12. The input 44 is positioned on one armrest 20 of the pair of armrests 20. The input 44 comprises a pair of buttons but may comprise a touchscreen, a switch, a dial, or the like. A charging port 46 is electrically coupled to the power supply 38 and is mounted to the support frame 12. The charging port 46 comprises a universal serial bus port. The input 44 is positioned on the one armrest 20. A headrest 48 is mounted to the backrest 26 and is positioned on the body support surface 32. The headrest 48 may comprise a compressible material such that the headrest 48 cushions a head of the user.

In use, the user lies on the upper surface 24 of the seat 22 and the body support surface 32 of the backrest 26 and operates the input 44 to alternately raise and lower the backrest 26 as desired. The chair apparatus 10 is typically placed so that the solar panel 42 receives sunlight such that it can convert solar energy into electricity. Electronic devices may be connected to the charging port 46 to receive electrical power from the battery 40 into the electronic device.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A chair apparatus comprising:
a support frame;
a seat being coupled to the support frame, the seat having an upper surface configured for supporting a user;
a backrest being pivotally coupled to the seat, the backrest being movable between a lowered position and a raised position, a body support surface of the backrest facing upwardly and lying coplanar to the upper surface of the seat when the backrest is positioned in the lowered position, the body support surface forming an obtuse angle with the upper surface of the seat when the backrest is positioned in the raised position;
a lift mechanism being operably coupled to the backrest wherein the lift mechanism is operable to move the backrest between the lowered position and the raised position;
a power supply being electrically coupled to the lift mechanism, the power supply comprising a battery; and
a solar panel being electrically coupled to the battery.

2. The apparatus of claim 1, wherein:
the support frame comprises a pair of legs and a main body, the main body being coupled to and extending between the pair of legs, each leg of the pair of legs being elongated and having an arch shape, a central portion of each leg of the pair of legs being spaced upwardly from the main body and defining one of a pair of armrests; and
the seat is positioned on the main body.

3. The apparatus of claim 2, wherein the solar panel is positioned on a portion of the main body which extends outwardly from a distal edge of the backrest relative to the seat when the backrest is positioned in the lowered position.

4. The apparatus of claim 2, further comprising an input being operatively coupled to the lift mechanism, the input being mounted to the support frame, the input being positioned on one armrest of the pair of armrests.

5. The apparatus of claim 2, further comprising a charging port being electrically coupled to the power supply, the charging port being mounted to the support frame, the input being positioned on the one armrest.

6. The apparatus of claim 1, further comprising an input being operatively coupled to the lift mechanism.

7. The apparatus of claim 1, further comprising a charging port being electrically coupled to the power supply.

8. The apparatus of claim 1, further comprising the lift mechanism comprising a linear actuator.

9. The apparatus of claim 1, further comprising a headrest being mounted to the backrest and being positioned on the body support surface.

10. A chair apparatus comprising:
a support frame, the support frame comprising a pair of legs and a main body, the main body being coupled to and extending between the pair of legs, each leg of the pair of legs being elongated and having an arch shape, a central portion of each leg of the pair of legs being spaced upwardly from the main body and defining one of a pair of armrests;
a seat being coupled to the support frame, the seat having an upper surface configured for supporting a user, the seat being positioned on the main body;
a backrest being pivotally coupled to the seat, the backrest being movable between a lowered position and a raised position, a body support surface of the backrest facing upwardly and lying coplanar to the upper surface of the seat when the backrest is positioned in the lowered position, the body support surface forming an obtuse angle with the upper surface of the seat when the backrest is positioned in the raised position;
a lift mechanism being operably coupled to the backrest wherein the lift mechanism is operable to move the backrest between the lowered position and the raised position, the lift mechanism comprising a linear actuator;
a power supply being electrically coupled to the lift mechanism, the power supply comprising a battery, the power supply being mounted to the support frame;
a solar panel being electrically coupled to the battery, the solar panel being mounted to the support frame, the solar panel being positioned on a portion of the main body which extends outwardly from a distal edge of the backrest relative to the seat when the backrest is positioned in the lowered position;
an input being operatively coupled to the lift mechanism, the input being mounted to the support frame, the input being positioned on one armrest of the pair of armrests;
a charging port being electrically coupled to the power supply, the charging port being mounted to the support frame, the input being positioned on the one armrest; and
a headrest being mounted to the backrest and being positioned on the body support surface.
